(19) United States
(12) Patent Application Publication
(10) Pub. No.: US 2010/0183249 A1
(43) Pub. Date: Jul. 22, 2010

(54) Packaging Container

(75) Inventors: Johannes Wedi, Emsdetten (DE); Rudolf Haimerl, Konzell (DE); Peter Strübbe, Lengerich (DE)

Correspondence Address: GUDRUN E. HUCKETT DRAUDT, SCHUBERTSTR. 15A, WUPPERTAL, 42289, DE

(73) Assignee: BISCHOF + KLEIN GMBH & CO. KG, Lengerich (DE)

(21) Appl. No.: 12/664,389

(22) PCT Filed: May 30, 2008
(86) PCT No.: PCT/EP08/04300

§ 371 Date: Dec. 12, 2009

(30) Foreign Application Priority Data
Jun. 16, 2007 (DE) 10 2007 027 784.0

(51) Int. Cl. B65D 30/20; B31B 19/60

(52) U.S. Cl. 383/120; 493/210

(57) ABSTRACT

The invention relates to a packaging container of multilayer plastic foil which can be sealed with at least one layer lying on the container inner side. The packaging container has two primary walls (2, 2a) lying opposite each other and placed opposite each other in a top sealing seam (14), and two side fold walls (3, 4) which are folded into the top sealing seam (14) as a double layer, flat between the primary walls (2, 2a) and toward the inside, with folded edges (7, 8) oriented against each other. The invention is improved in the sense of prespecified air-tightness and aroma-tightness, with minimal work and material requirements, in that a closure plug (16) made out of a hot melt mass is arranged inside the sealing seam (14) directly in front of each folded edge (7, 8).

The invention concerns a packaging container according to the preamble of claim 1 as well as a method for producing such a packaging container according to the preamble of claim 10.

Packaging containers of plastic film in the form of bags or sacks are provided in a wide range and a plurality of embodiments for different packaging purposes. For fulfilling general requirements with respect to airtight and moisture-tight packaging containers of this kind, usually multi-layer films are employed already wherein, for example, an inner layer made of polyolefin, in particular polyethylene of a low melting point, ensures that the film at this side of the layer is sealable and at the same time provides a moisture barrier while a polyester layer on the exterior side is matched with respect to airtightness, tear strength, and printability.

Such conventional material combinations for the layers of plastic films of packaging containers are however not yet suitable to achieve high requirements with regard of gas tightness and/or aroma tightness, for example, with respect to sensitive foodstuffs, feed, or other packaged goods. In this context, there exists the necessity of employing plastic films with a barrier layer, for example, of ethylene vinyl acetate (EVA) based on polyethylene or an EVOH. Also, metallic barrier layers are conceivable. In this way, gas-tight and aroma-tight container surfaces can be ensured that however in connecting areas, for example, in case of sealing seams between adjoining wall or bottom surfaces must be sealed throughout and, in particular also with respect to incorporated reclosable closures must fulfill the seal-tightness requirements. For example, in case of slider closures the closure itself with its interlocking profile is an extruded product that generally cannot be made of a thermoplastic synthetic material so as to be gas-tight and aroma-tight, in particular because the interlocking action itself provides no reliable sealing action. However, such a slider closure provided with contiguous connecting webs can be sealed in at the top side of such a packaging container wherein these connecting webs are then made of a material that has a satisfactorily high gas and/or aroma tightness and that, on the other hand, is provided with a low melting sealable exterior layer or with appropriate welding ribs.

However, it has been found that these measures, even when applied consequently, are not sufficient in order to modify a packaging container of the conventional kind into one that has high gas tightness and aroma tightness. To the contrary, in practical application, despite all due care in the manufacture of such packaging containers, leaks were still observed.

Object of the invention is therefore to configure a packaging container of the aforementioned kind in an embodiment with multi-layer plastic film that is provided also with satisfactory barrier properties in a way such that a predetermined gas and aroma tightness can be achieved, wherein such a packaging container should be producible with a work expenditure and material expenditure as low as possible and, as much as possible, with conventional, tried and tested manufacturing technologies.

According to the invention, this object is solved on the one hand with a multi packaging container according to the preamble of claim 1 based on the characterizing features of claim 1 and on the other hand with a method according to the preamble of claim 10 based on the characterizing features of claim 10.

The invention is based on the finding that the sealing seams represent weak points in case of suitable barrier materials at locations where transitions of the number of layers of the plastic film must be overcome. When provided with special barrier layers, they cause greater thickness of the individual layers and thus also greater total thickness of the sealing seams. Moreover, the barrier layers effect a great stiffness and bulkiness of the plastic film. This is noticeable in particular at the fold edges of the gusset walls in the sense of disruptive locations at the top sealing seam where then leakage may occur easily.

This weak point according to the invention can be eliminated by a closure plug of a hot melt material that is provided immediately in front of each fold edge of the gusset walls within the sealing seam. Process-technologically such a plug of hot melt material is applied onto one of the sealable surfaces, for example, onto the fold edge itself or simply and reliably onto one of the sealable neighboring surfaces, for example, the inner side of one of the main walls or a neighboring exterior wall of a slider connecting web, and is then melted when the top sealing seam is produced in order to close the cross-section of the top sealing seam not only by means of the available sealable layers of the neighboring walls but also particularly by this plug.

The hot melt material can be basically a low-melting polyethylene (PE) as it is used for the surface or the welding ribs of the slider connecting webs. However, another thermoplastic material with a low melting point may be used as well. Polyethylene that is used often for the sealable inner layers of plastic film for such packaging containers and optionally also for the instant containers is routinely not suitable because usually it is ropy and therefore can be metered drop-wise only with difficulty and because it also decomposes when being stored in the melted state over an extended period of time. It is also advantageous when the hot melt material has a lower melting point than the sealable layer of the neighboring plastic films in order to achieve melting and optionally also low viscosity in an inwardly positioned area that is relatively far removed from the externally gripping sealing jaws of a tool.

Two embodiments of the invention are illustrated in the drawing and will be explained in the following in more detail. The drawing show in:

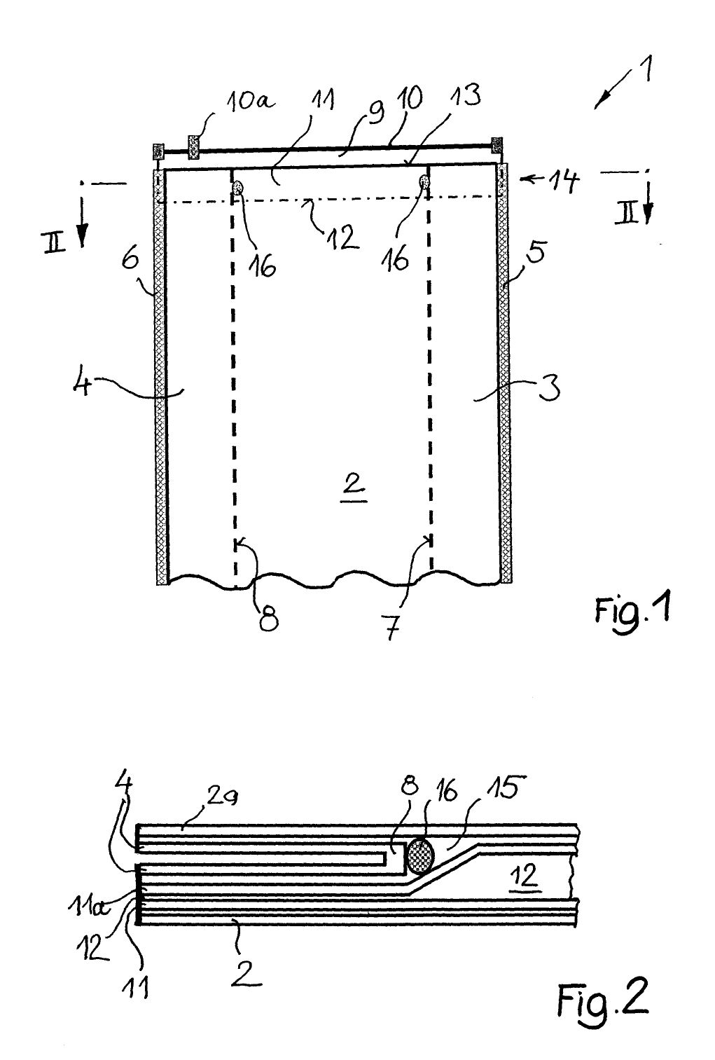

FIG. 1 a front view of a packaging container in a first embodiment;

FIG. 2 an enlarged section according to line II-II of FIG. 1; and

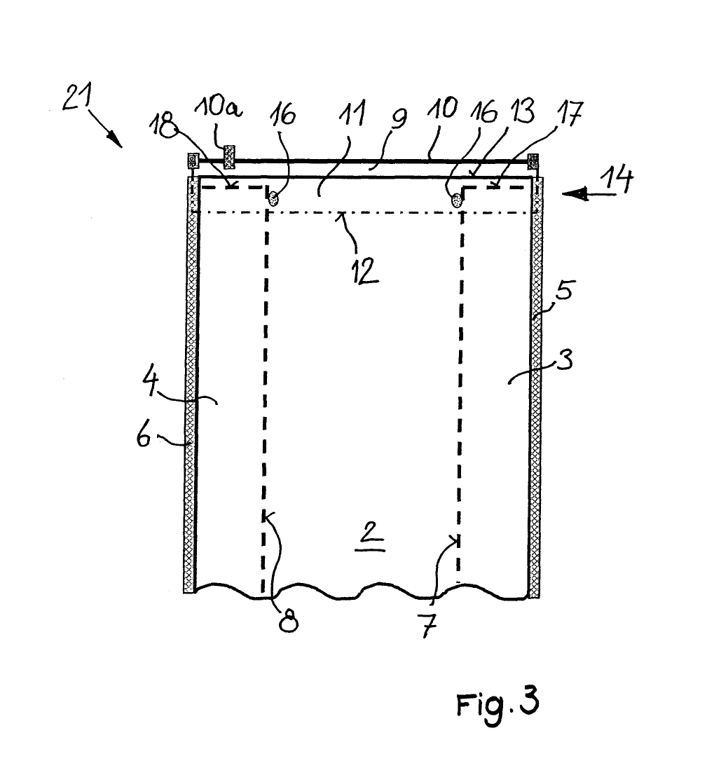

FIG. 3 a view in accordance with FIG. 1 of a modified embodiment with gussets that are shortened at the top end.

In FIG. 1 a packaging container 1 is illustrated in an aroma-tight embodiment with its top end in a front view shown in unfilled state wherein a front wall 2, forming together with a congruent rear wall the two main walls of the plastic bag 1, is connected at both sides with inwardly folded gusset walls 3 and 4 by means of lateral sealing seams 5 and 6; the gusset walls, in turn, project to fold edges 7 and 8 inwardly into the packaging container 1. From above a strip-shaped reclosable closure, provided with two interlocking profiled strips at the upper end and with a slider 10a for opening and closing, is inserted with double-layer contiguous connecting webs 11 extending to a fold edge 12 that is parallel to the top edge 13 of the front wall 2. The gussets end at the top flush with the top edge 13.

In an upper area of the packaging container 1 along the entire top edge 13 a top sealing seam 14 is formed that must not fulfill a minimum width but, in general, for safety reasons is relatively wide, preferably extends across the entire area between the fold edge 12 and the top edge 13 from the lateral sealing seam 5 to the lateral sealing seam 6.

FIG. 2 shows a cross-sectional area of the top sealing seam 14 in a left area that includes the gusset 4. The gusset 4 is resting with a gusset half of the gusset against the rear wall 2a that matches the front wall 2 of the packaging container and with the other gusset half against the connecting web 11a that is congruent to the connecting web 11 and is connected with it in the area of the lower fold 12. Upon initial opening of the container for first use the connecting webs 11 and 11a are separated from one another by cutting or by tearing along a predetermined tear line. Up to this point they form a continuous wall in the top area. The connecting web 11 is resting in turn against the front wall 2. All film walls illustrated in cross-section are at least at one side provided with a sealable surface, for example, a low-melting polyolefin layer such as PE and PP, that is positioned on the side facing the interior of the container. In this way, the container rear wall 2a is fixedly and seal-tightly connected with neighboring gusset half of the gusset wall 4 while the other gusset half 4 is sealed with the half 11a—facing the interior of the container—of the connecting web of the reclosable closure. The connecting web 11 of the reclosable closure is in turn connected to the front wall 2. The two halves of the gusset wall 4 are positioned on top one another without being connected but are closed off by the fold edge 8 while the connecting webs 11a and 11 that are upwardly open and unconnected are closed downwardly by the fold edge 12.

The cross-sectional illustration according to FIG. 2 shows that the top sealing seam must overcome a problematic transition in the area before the fold edge 8 of the gusset wall 4 where a vertical intermediate space 15 is formed. This space is even more critical in comparison to comparable bag configurations in that the films with respect to gas tightness and aroma tightness are provided with barrier layers that reinforce these films with respect to thickness and/or stiffness. At this location even for carefully selected materials and careful execution of the sealing action there is the risk of leakage. This risk is counteracted according to the invention by means of a plug 16 of hot melt material that is arranged within the sealing seam immediately before the fold edge 8 (and likewise in front of the fold edge 7) and therefore closes off the intermediate space 15 during sealing. The position of the plug 16 can be selected to be higher or lower in front of the fold edge 8 as long as the location is still within the area of the top sealing seam 14 and during sealing causes the plug to soften and close off the intermediate space 15.

The size of the plug allows for variations as long as the closure is realized. Excess material is pushed out upon sealing upwardly or downwardly.

The plug 16 is comprised of a hot melt material that should be easily processible. In particular, it is to be selected from a group of known hot melt materials that over an extended period of time can be kept heated automatically, can be easily metered and in particular is not ropy as is the case for polyethylene of the materials that are commonly used for layers of plastic films in the field of packaging containers. Expediently, the melting point of the hot melt material is also selected to be lower than the melting point of the sealable layers so that an early melting and excellent distribution of the plug is enabled and so that this is also realized in an inward situation where the heat of the sealing jaws must pass through several layers. Such a melting temperature also does not interfere with the stepped melting points of the layers of the plastic films used for the packaging container in which, for example, an inner layer of polyethylene melts at a much lower temperature than an outer layer of polyester so that only the inner layer will participate in the sealing action.

The embodiment of a packaging container 21 illustrated in FIG. 3 is substantially identical to that of FIGS. 1 and 2 so that the reference numerals used therein are employed here. However, the gusset walls have shorter upper edges 17, 18 that end within the top sealing seam 14. This is a measure to close off the gussets internally. However, this measure also has been found to be unsatisfying with respect to eliminate the afore described leakage in the top sealing seam 14 in front of the fold edges 7 and 8. For example, gas escaping here cannot exit upwardly because the sealing seam extends continuously here and after elimination of the gussets 4 connects the connecting web 11 and 11a seal-tightly to the main walls 2 and 2a. However, along the upper gusset edges 17 and 18 corresponding intermediate spaces are formed and the escaped gas can pass along the fold edges 7 and 8 and about the upper end into the free intermediate space between the layers of the gusset wall 4 or 3 and can thus escape. This is counteracted by an appropriate plug 16.

The leakage problem that is solved here occurs even when at the top side of the packaging container 1 the recloseable closure 9 is not employed, i.e., when the packaging container is closed off by the top sealing seam and remains open upon removal of the top sealing seam or opening of the packaging container in other ways. In this situation the intermediate walls 11 and 11a shown in FIG. 2 are not present but the leakage problem then occurs between the remaining layers and is also solvable by means of the plug 16.

With respect to method technology the plug is applied during joining of the walls of the bag after the gussets are secured at least on one of the main surfaces and the fold edges of the gusset walls are fixed. The plug 16 is then applied in front of the fold edges, respectively. The sealing action of the corresponding problem area is then realized with a conventional sealing measure without this requiring special further working steps or special machine-based measures during sealing.

What is claimed is:

1.-10. (canceled)

11. A packaging container comprising:
two opposed main walls;
two connecting gusset walls connecting the main walls with one another, respectively;
wherein the main walls and the gusset walls are comprised of a multilayer plastic film that is sealable by at least one sealable layer located at an inwardly facing side of the container;
wherein the two main walls are resting against one another in a top sealing seam and wherein the two gusset walls are inwardly folded in a double-layer flat arrangement between the main walls and have oppositely oriented fold edges within the top sealing seam;
wherein within the top sealing seam immediately in front of each fold edge a closure plug of a hot melt material is arranged.

12. The packaging container according to claim 11, wherein the closure plug is comprised of a hot melt material that is not ropy.

13. The packaging container according to claim 11, wherein the hot melt material has a lower melting point than the at least one sealable layer of the multilayer plastic film.

14. The packaging container according to claim 13, wherein the multilayer plastic film has at least one additional layer of a melting point that is higher than the melting point of the at least one sealable layer.

15. The packaging container according to claim 14, wherein the at least one sealable layer is a polyethylene layer and wherein the at least one additional layer is a polyester layer.

16. The packaging container according to claim 15, wherein the multilayer plastic film comprises at least one seal-tight barrier layer.

17. The packaging container according to claim 11, wherein the gusset walls extend upwardly past the top sealing seam.

18. The packaging container according to claim 11, wherein the gusset walls end within the top sealing seam.

19. The packaging container according to claim 11, further comprising a strip-shaped reclosable closure with double-layer, contiguous connecting webs that have externally positioned sides that are sealable, wherein the reclosable closure is inserted between one of the main walls and the double-layer inwardly folded gusset walls.

20. A method for producing a packaging container from a multilayer sealable plastic film that has at least one sealable layer located at an inner side of the packaging container, wherein the packaging container comprises two opposed main walls that are resting flat against one another in a top sealing seam and further comprises two connecting gusset walls connecting the main walls with one another, respectively; the method comprising the steps of:
before the top sealing seam is being formed, folding the two connecting gusset walls inwardly between the main walls in a double-layer flat arrangement with oppositely oriented fold edges and applying a closure plug of a hot melt material onto one of the sealable surfaces immediately in front of each fold edge.
